(19) United States
(12) Patent Application Publication
(10) Pub. No.: US 2017/0242293 A1
(43) Pub. Date: Aug. 24, 2017

(54) COLOR FILTER SUBSTRATE AND LIQUID CRYSTAL DISPLAY PANEL

(71) Applicant: WUHAN CHINA STAR OPTOELECTRONICS TECHOLOGY CO., LTD., Wuhan (CN)

(72) Inventor: Haibo PENG, Wuhan (CN)

(21) Appl. No.: 15/342,173

(22) Filed: Nov. 3, 2016

(30) Foreign Application Priority Data
Feb. 18, 2016 (CN) 201610090768.1

(51) Int. Cl. G02F 1/1335; G02F 1/13363

(52) U.S. Cl. CPC G02F 1/133514; G02F 1/13363; G02F 1/133528; G02F 2201/52; G02F 2202/022; G02F 2001/133633

(57) ABSTRACT

A color filter substrate and a liquid crystal display panel are described. The color filter substrate has: a base substrate; a color resist layer disposed on a surface of the base substrate and formed with color resist blocks each configured to filter a light with a predetermined wavelength and emits a target light; a compensating film disposed on the other surface of the base substrate and having compensating units corresponding to the color resist blocks and facing toward the corresponding color resist blocks, respectively; and an upper polarizing sheet disposed on the compensating film. A first compensating specific value Re and a second compensating, specific value Rth of each of the compensating units respectively satisfy the following relationships: Re/λ=A, Rth/λ=B, Re=(Nx−Ny)*d, Rth=[(Nx+Ny)/2−Nz]*d. Thus, the light leakage problem can be eliminated, and a user's experience can be improved.

### FIELD OF THE INVENTION

The present invention relates to a display field, and more particularly to a color filter substrate and a liquid crystal display panel.

### BACKGROUND OF THE INVENTION

In the conventional technologies, liquid crystal displays under a TN mode and a VA mode exist a serious problem of light leakage in directions of wide viewing angles. Although an in-plane switching (IPS) technology and a fringe field switching (FFS) technology have relative advantages in this aspect, a purpose of the desired liquid crystal displays having identical viewing effects in different viewing angles still cannot be achieved. In order to solve the problem of poor display effects in directions of wide viewing angles due to the light leakage, various types of compensating film polarizing sheets have wide applications. However, in view of actual effects, in spite of the problem of light leakage being improved significantly, the problem cannot be eliminated entirely. In the case of front viewing, a linear polarizing light passing through a lower polarizing sheet is exactly reversed 90 degrees upon a dark state and then is absorbed by an upper polarizing sheet. At this time, the problem of light leakages does not exist. However, in the case of viewing obliquely, the linear polarizing light passing through the lower polarizing sheet will be distorted over 90 degrees since an emitting light path is changed. At this time, the upper polarizing sheet can only absorb a part of the light, and the problem of light leakage is produced.

### SUMMARY OF THE INVENTION

An object of the present invention is to provide an improved color filter substrate and an improved liquid crystal display panel for solving a technical problem of a poor display screen phenomenon due to the problem of light leakage in the conventional color filter substrate and liquid crystal display panel.

To solve the above problems, the present invention provides a technical solution as follows:

A color filter substrate is provided and comprises:

a base substrate;

a color resist layer disposed on a surface of the base substrate, wherein the color resist layer has a plurality of color resist blocks and each of the color resist blocks is configured respectively to filter a light with a predetermined wavelength and emits a target light;

a compensating film disposed on the other surface of the base substrate and formed with a plurality of compensating units, wherein the compensating units are respectively one-to-one corresponding to the color resist blocks, and the compensating units face toward the corresponding color resist blocks, respectively; and

an upper polarizing sheet disposed on the compensating film;

wherein a first compensating specific value Re and a second compensating specific value Rth of each of the compensating units respectively satisfy the following relationships:

Re/λ=A;

Rth/λ=B;

Re=(Nx−Ny)*d; and

Rth=[(Nx+Ny)/2−Nz]*d,

wherein λ is a wavelength value of the target light corresponding to the compensating unit; A and B are both constant values; Nx, Ny, and Nz are refractive indices of the target light in an X direction, a Y direction, and a Z direction of the compensating unit, respectively, wherein the X direction and the Y direction are perpendicular to each other and are both parallel to the compensating unit, the Z direction is vertical to the compensating unit, and d is a thickness of the compensating unit.

In the color filter substrate of the present invention, the color resist, layer is a red/green/blue color resist layer, a red/green/blue/green color resist layer or a red/green/blue/white color resist layer.

In the color filter substrate of the present invention, the upper polarizing sheet comprises a first triacetate cellulose layer, a polyvinyl alcohol layer, and a second triacetate cellulose layer, all of which are stacked in turn.

In the color filter substrate of the present invention, a thickness of the color resist layer is between 500 nm and 2000 nm.

In the color filter substrate of the present invention, the compensating film is a liquid crystal layer coated on the base substrate.

The present invention further provides a liquid crystal display panel comprising a color filter substrate, an array substrate and a liquid crystal layer disposed between the color filter substrate and the array substrate, wherein the color filter substrate comprises:

a base substrate:

a color resist layer disposed on a surface of the base substrate, wherein the color resist layer has a plurality of color resist blocks and each of the color resist blocks is configured respectively to filter a light with a predetermined wavelength and emits a target light;

a compensating film disposed on the other surface of the base substrate and formed with a plurality of compensating units, wherein the compensating units are respectively one-to-one corresponding to the color resist blocks, and the compensating units face toward the corresponding color resist blocks, respectively; and

an upper polarizing sheet disposed on the compensating film;

wherein a first compensating specific value Re and a second compensating specific value kith of each of the compensating units respectively satisfy the following relationships:

Re/λ=A;

Rth/λ=B;

Re=(Nx−Ny)*d; and

Rth=[(Nx+Ny)/2−Nz]*d,

wherein λ is a wavelength value of the target light corresponding to the compensating unit; A and B are both constant values; Nx, Ny, and Nz are refractive indices of the target light respectively in a X direction, a Y direction, and a Z direction of the compensating unit, respectively, wherein the X direction and the Y direction are perpendicular to each other and are both parallel to the compensating unit, the Z direction is vertical to the compensating unit, and d is a thickness of the compensating unit.

In the liquid crystal display panel of the present invention, the color resist layer is a red/green/blue color resist layer, a red/green/blue/green color resist layer or a red/green/blue/white color resist layer.

In the liquid crystal display panel of the present invention, the upper polarizing sheet comprises a first triacetate cellulose layer, a polyvinyl alcohol layer, and a second triacetate cellulose layer, all of which are stacked in turn.

In the liquid crystal display panel of the present invention, a thickness of the color resist layer is between 500 nm and 2000 nm.

In the liquid crystal display panel of the present invention, the compensating film is a liquid crystal layer coated on the base substrate.

A color filter substrate and a liquid crystal display panel provided by preferred embodiments of the present invention are to divide the compensating film into a plurality of compensating units, and each of the compensating units is corresponding to and faces toward a color resist block, such that a first compensating specific value Re and a second compensating specific value Rth of each of the compensating units is controlled and a compensating film can compensate for lights with different colors. A compensation for multiple colors is perfectly performed. The light leakage problem can be eliminated, and a user's experience can be improved.

To make the above description of the present invention more clearly comprehensible, it is described in detail below in examples of preferred embodiments with the accompanying drawings.

### DESCRIPTION OF THE DRAWINGS

FIG. 1 is a structural schematic diagram of a preferred embodiment of a color filter substrate of the present invention; and

FIG. 2 is a using schematic diagram of a preferred embodiment of a liquid crystal display panel of the present invention.

### DETAILED DESCRIPTION OF THE PREFERRED EMBODIMENTS

The following description of the embodiments with reference to the appended drawings is used for illustrating specific embodiments which may be used for carrying out the present invention. The directional terms described by the present invention, such as “upper”, “lower”, “front”, “back”, “left”, “right”, “inner”, “outer”, “side”, etc., are only directions by referring to the accompanying drawings. Thus, the used directional terms are used to describe and understand the present invention, but the present invention is not limited thereto.

In figures, elements with similar structures are indicated by the same numbers.

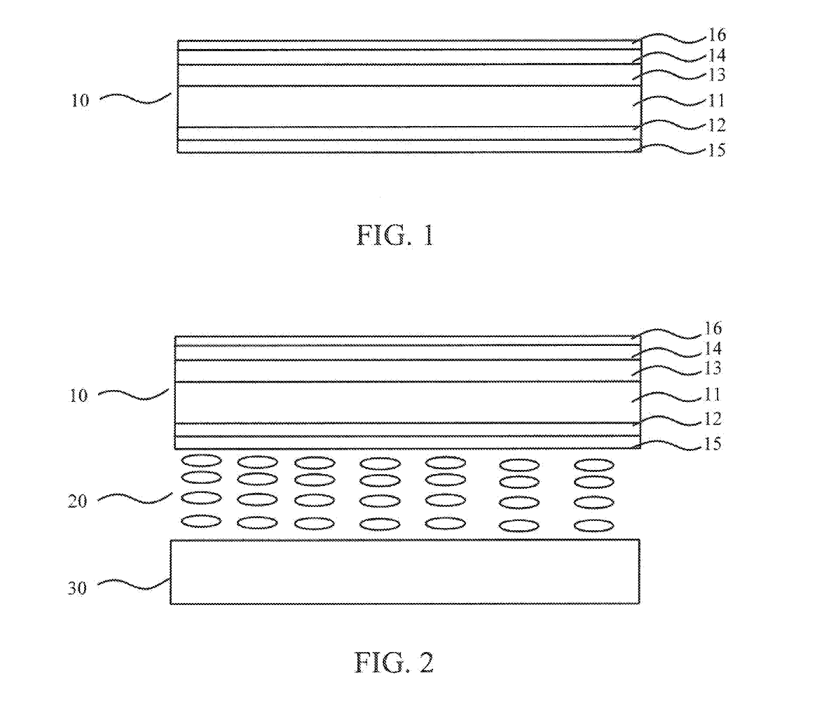

Please refer to FIG. 1, which is a structural schematic diagram of a preferred embodiment of a color filter substrate of the present invention.

A color filter substrate 10 of a preferred embodiment of the present invention comprises a base substrate 11, a color resist layer 12, a compensating film 13, an upper polarizing sheet 14, a flat layer 15, and a protective film layer 16. The color resist layer 12 is disposed on a surface of the base substrate 11, and the flat layer 15 is disposed on the color resist layer 12. The compensating film 13 is disposed on the other surface of the base substrate 11, the upper polarizing sheet 14 is disposed on the base substrate 11, and the protective film layer 16 covers and is disposed on the upper polarizing sheet 14.

In some embodiments the base substrate 11 can use a glass substrate.

in some embodiments, the upper polarizing sheet 14 comprises a first triacetate cellulose layer, a polyvinyl alcohol layer, and a second triacetate cellulose layer, all of which are stacked in turn. The first triacetate cellulose layer and the second triacetate cellulose layer are mainly used to protect polarizers, fix polarizers, improve a contrast, improve a wide-angle and so on.

In some embodiments, the color resist layer 12 can be a red/green/blue color resist layer, a red/green/blue/green color resist layer or a red/green/blue/white color resist layer. Of course, it is not limited to this, and the color resist layer 12 can be other color resist layers. The color resist layer 12 has a plurality of color resist blocks and each of the color resist blocks is configured respectively to filter a light with a predetermined wavelength and emits a target light. For example, when the color resist layer 12 is the red/green/blue color resist layer comprising a plurality of red color resists, green color resists, and blue color resists, a red color resist, a corresponding green color resist and a corresponding blue color resist constitute a base pixel unit. When the color resist layer 12 is the red/green/blue/white color resist layer comprising a plurality of red color resists, green color resists, blue color resists and white color resists, a red color resist, a corresponding green color resist, a corresponding blue color resist, and a corresponding white color resist constitute a base pixel unit. In the present embodiment, a thickness of the color resist layer 12 is between 500 nm and 2000 nm. Of course, it is not limited thereto.

In some embodiments, the compensating film 13 can be a liquid crystal layer coated on the base substrate 11. Of course, other materials can be used. The compensating film 13 is formed with a plurality of compensating units, which means that the compensating units constitute the compensating film 13. The compensating units are respectively one-to-one corresponding to the color resist blocks, and the compensating units face toward the corresponding color resist blocks, respectively.

Specifically, a first compensating specific value Re and a second compensating specific value Rth of each of the compensating units respectively satisfy the following relationships:

Re/λ=A;

Rth/λ=B;

Re=(Nx−Ny)*d; and

Rth=[(Nx+Ny)/2−Nz]*d,

wherein λ is a wavelength value of the target light corresponding to the compensating unit; A and B are both constant values; Nx, Ny, and Nz are refractive indices of the target light in a X direction, a Y direction and a Z direction of the compensating unit, respectively, wherein the X direction and the Y direction are perpendicular to each other and are both parallel to the compensating unit, the Z direction is vertical to the compensating unit, and d is a thickness of the compensating unit.

Specifically, for example, when the color resist layer 12 is the red/green/blue color resist layer, the first compensating specific values corresponding thereto satisfy Re(red):Re(green):Re(blue)=λ(red):(green):λ(blue), which means Re(red)/λ(red)=Re(green)/λ(green)=Re(blue)/λ(blue)=constant; and the second compensating specific values corresponding thereto satisfy Rth(red):Rth(green):Rth(blue)=λ(red):λ(green):λ(blue), which means Rth(red)/λ(red)=Rth(green)/λgreen)=Rth(blue)/λ(blue)=constant.

Further, in the present embodiment, when the compensating film 13 is a liquid crystal layer, which means that use liquid crystal molecules as compensating molecules of the compensating film 13, Re and Rth of each of the compensating film 13 can be controlled by using a method of controlling vertical tilting angles and horizontal azimuth angles of the liquid crystal molecules. Or, the vertical tilting angle and the horizontal azimuth angle of each of the liquid crystal molecules are kept the same by controlling the thickness of each of the compensating units, thereby achieving a purpose of controlling Re and Rth of each of the compensating film 13.

The color filter substrate 10 provided by a preferred embodiment of the present invention is to divide the compensating film 13 into a plurality of compensating units, and each of the compensating units is corresponding to and faces toward a color resist block, such that a first compensating specific value Re and a second compensating specific value Rth of each of the compensating units is controlled and a compensating film 13 can compensate for lights with different colors. A compensation for multiple colors is perfectly performed. The light leakage problem can be eliminated, and a user's experience can be improved.

Please referring to FIG. 2, which is a structural schematic diagram of a preferred embodiment of a liquid crystal display panel of the present invention.

The liquid crystal display panel of the preferred embodiment of the invention comprises a color filter substrate 10, an array substrate 20, and a liquid crystal layer 30 disposed between the color filter substrate 10 and the array substrate 20.

In some embodiments, the color filter substrate 10 comprises a base substrate 11, a color resist layer 12, a compensating film 13, an upper polarizing sheet 14, a flat layer 15, and a protective film layer 16. The color resist layer 12 is disposed on a surface of the base substrate 11, and the flat layer 15 is disposed on the color resist layer 12, The compensating film 13 is disposed on the other surface of the base substrate 11, the upper polarizing sheet 14 is disposed on the base substrate 11, and the protective film layer 16 covers with and is disposed on the upper polarizing sheet 14.

In some embodiments, the base substrate 11 can use a glass substrate.

In some embodiments, the upper polarizing sheet 14 comprises a first triacetate cellulose layer, a polyvinyl alcohol layer, and a second triacetate cellulose layer, all of which are stacked in turn. The first triacetate cellulose layer and the second triacetate cellulose layer are mainly used to protect polarizers, fix polarizers, improve a contrast, improve a wide-angle and so on.

In some embodiments, the color resist layer 12 can be a red/green/blue color resist layer, a red/green/blue/green color resist layer, or a red/green/blue/white color resist layer. Of course, it is not limited to this, and the color resist layer 12 can be other color resist layers. The color resist layer 12 has a plurality of color resist blocks and each of the color resist blocks is configured respectively to filter a light with a predetermined wavelength and emits a target light. For example, when the color resist layer 12 is the red/green/blue color resist layer comprising a plurality of red color resists, green color resists and blue color resists, a red color resist, a corresponding green color resist and a corresponding blue color resist constitute a base pixel unit. When the color resist layer 12 is the red/green/blue/white color resist layer comprising a plurality of red color resists, green color resists, blue color resists, and white color resists, a red color resist, a corresponding green color resist, a corresponding blue color resist, and a corresponding white color resist constitute a base pixel unit. In the present embodiment, a thickness of the color resist layer 12 is between 500 nm and 2000 nm. Of course, it is not limited thereto.

In some embodiments, the compensating film 13 can be a liquid crystal layer coated on the base substrate 11. Of course, other materials can be used. The compensating film 13 is formed with a plurality of compensating units, which means that the compensating units constitute the compensating film 13. The compensating units are respectively one-to-one corresponding to the color resist blocks, and the compensating units face toward the corresponding color resist blocks, respectively.

Specifically, a first compensating specific value Re and a second compensating specific value Rth of each of the compensating units respectively satisfy the following relationships:

Re/λ=A;

Rth/λ=B;

Re=(Nx−Ny)*d; and

Rth=[(Nx+Ny)/2−Nz]*d,

wherein λ is a wavelength value of the target light corresponding to the compensating unit; A and B are both constant values; Nx, Ny, and Nz are refractive indices of the target light in a X direction, a Y direction, and a Z direction of the compensating unit, respectively, wherein the X direction and the Y direction are perpendicular to each other and are both parallel, to the compensating unit, the Z direction is vertical to, the compensating unit, and d is a thickness of the compensating unit.

Specifically, for example, when the color resist layer 12 is the red/green/blue color resist layer, the first compensating specific values corresponding thereto satisfy Re(red):Re(green):Re(blue)=λ(red):λ(green):λ(blue), which means Re(red)/λ(red)=Re(green)/λ(green)=Re(blue)/λ(blue)=constant; and the second compensating specific values corresponding thereto satisfy Rth(red):Rth(green):Rth(blue)=λ(red):λ(green):λ(blue), which means Rth(red)/λ(red)=Rth(green)/λ(green)=Rth(blue)/λ(blue)=constant.

Further, in the present embodiment, when the compensating film 13 is a liquid crystal layer, which means that use liquid crystal molecules as compensating molecules of the compensating film 13, Re and Rth of each of the compensating film 13 of the compensating film 13 can be controlled by using a method of controlling vertical tilting angles and horizontal azimuth angles of the liquid crystal molecules. Or, the vertical tilting angle and the horizontal azimuth angle of each of the liquid crystal molecules are kept the same by controlling the thickness of each of the compensating units, thereby achieving a purpose of controlling Re and Rth of each of the compensating film 13.

The color filter substrate and the liquid crystal display panel provided by preferred embodiments of the present invention are to divide the compensating film 13 into a plurality of compensating units, and each of the compensating units is corresponding to and faces toward a color resist block, such that a first compensating specific value Re and a second compensating specific value Rth of each of the compensating units is controlled and a compensating film 13 can compensate for lights with different colors. A compensation for multiple colors is perfectly performed. The light leakage problem can be eliminated, and a user's experience can be improved.

As described above, although the present invention has been described in preferred embodiments, they are not intended to limit the invention. One of ordinary skill in the art, without departing from the spirit and scope of the invention within, can make various modifications and variations, so the range of the scope of the invention is defined by the claims.

What is claimed is:

1. A color filter substrate, comprising:
a base substrate;
a color resist layer disposed on a surface of the base substrate, wherein the color resist layer has a plurality of color resist blocks and each of the, color resist blocks is configured respectively to filter a light with a predetermined wavelength and emits a target light;
a compensating film disposed on the other surface of the base substrate and formed with a plurality of compensating units, wherein the compensating units are respectively one-to-one corresponding to the color resist blocks, and the compensating units face toward the corresponding color resist blocks, respectively; and
an upper polarizing sheet disposed on the compensating film;
wherein a first compensating specific value Re and a second compensating specific value Rth of each of the compensating units respectively satisfy the following relationships:
Re/λ=A;
Rth/λ=B;
Re=(Nx−Ny)*d; and
Rth=[(Nx+Ny)/2−Nz]*d,
wherein λ is a wavelength value of the target light corresponding to the compensating unit; A and B are both constant values; Nx, Ny, and Nz are refractive indices of the target light in a X direction, a Y direction, and a Z direction of the compensating unit, respectively, wherein the X direction and the Y direction are perpendicular to each other and are both parallel to the compensating unit, the Z direction is vertical to the compensating unit, and d is a thickness of the compensating unit.

2. The color filter substrate according to claim 1, wherein the color resist layer is a red/green/blue color resist layer, a red/green/blue/green color resist layer, or a red/green/blue/white color resist layer.

3. The color filter substrate according to claim 1, wherein the upper polarizing sheet comprises a first triacetate cellulose layer, a polyvinyl alcohol layer and a second triacetate cellulose layer, all of which are stacked in turn.

4. The color filter substrate according to claim 1, wherein a thickness of the color resist layer is between 500 nm and 2000 nm.

5. The color filter substrate according to claim 1, wherein the compensating film is a liquid crystal layer coated on the base substrate.

6. A liquid crystal display panel, comprising a color filter substrate, an array substrate and a liquid crystal layer disposed between the color filter substrate and the array substrate, wherein the color filter substrate comprises:
a base substrate;
a color resist layer disposed on a surface of the base substrate, wherein the color resist layer has a plurality of color resist blocks and each of the color resist blocks is configured respectively to filter a light with a predetermined wavelength and emits a target light;
a compensating film disposed on the other surface of the base substrate and formed with a plurality of compensating units, wherein the compensating units are respectively one-to-one corresponding to the color resist blocks, and the compensating units face toward the corresponding color resist blocks, respectively; and
an upper polarizing sheet disposed on the compensating film;
wherein a first compensating specific value Re and a second compensating specific value Rth of each of the compensating units respectively satisfy the following relationships:
Re/λ=A;
Rth/λ=B;
Re=(Nx−Ny)*d; and
Rth=[(Nx+Ny)/2−−Nz]*d,
wherein λ is a wavelength value of the target light corresponding to the compensating unit; A and B are both constant values; Nx, Ny, and Nz are refractive indices of the target light respectively in a X direction, a Y direction, and a Z direction of the compensating unit, respectively, wherein the X direction and the V direction are perpendicular to each other and are both parallel to the compensating unit, the Z direction is vertical to the compensating unit, and d is a thickness of the compensating unit.

7. The liquid crystal display panel according to claim 6, wherein the color resist layer is a red/green/blue color resist layer, a red/green/blue/green color resist layer, or a red/green/blue/white color resist layer.

8. The liquid crystal display panel according to claim 6, wherein the upper polarizing sheet comprises a first triacetate cellulose layer, a polyvinyl alcohol layer, and a second triacetate cellulose layer, all of which are stacked in turn.

9. The liquid crystal display panel according to claim 6, wherein a thickness of the color resist layer is between 500 nm and 2000 nm.

10. liquid crystal display panel according to claim 6, wherein the compensating film is a liquid crystal layer coated on the base substrate.
